(19) United States
(12) Patent Application Publication
(10) Pub. No.: US 2026/0334511 A1
(43) Pub. Date: Oct. 29, 2026

(54) SYSTEM AND METHOD FOR PURIFYING ANIMAL PROTEIN MEAL

(71) Applicant: Joe Hubbard, Kansas City, MO (US)

(72) Inventor: Joe Hubbard, Kansas City, MO (US)

(21) Appl. No.: 19/347,036

(22) Filed: Oct. 1, 2025

Related U.S. Application Data
(60) Provisional application No. 63/796,309, filed on Apr. 28, 2025.

(51) Int. Cl. A23K 20/147; A23K 10/20; A23K 40/10

(52) U.S. Cl. CPC A23K 20/147; A23K 10/20; A23K 40/10

(57) ABSTRACT

A method for purifying animal protein meal whereby particles are separated by weight or density, sieved to remove oversized material, and passed through a magnetic separator to remove ferromagnetic contaminants. The separation produces a heavier fraction enriched in ash and a lighter fraction with reduced ash, each being collected in separate containers. In one embodiment, oversized particles retained during sieving are milled and reintroduced into the process. A system for performing the method includes an air classifier, conveyor system, sieving modules, magnetic separators, and storage containers, and may further include an auger for feeding material to the classifier. The method and system reduce contaminants such as bone fragments, plastics, and metals while producing purified protein meal with controlled nutritional content suitable for animal feed applications.

### CROSS-REFERENCE TO RELATED APPLICATIONS

The present application is a nonprovisional application and claims the benefit of priority under 35 U.S.C. § 119(e) of U.S. Nonprovisional Application No. 63/796,309 entitled “SYSTEM AND METHOD FOR PURIFYING ANIMAL PROTEIN MEAL,” filed on Apr. 28, 2025 by Joe Hubbard, the entirety of which is hereby incorporated by reference.

### STATEMENT REGARDING FEDERALLY SPONSORED RESEARCH OR DEVELOPMENT (IF APPLICABLE)

N/A

### BACKGROUND OF THE INVENTION

### Field of the Invention

This invention relates generally to animal feeding-stuffs, and more particularly to working-up of proteins for foodstuffs.

### Background of the Prior Art

This invention addresses several problems in the prior art of preparing animal protein meal for use in pet-food grade and feed-grade products.

Animal protein meal is a powder made from processing or rendering animal tissue and is often used in agriculture and as food for animals. The content and quality of animal protein meal is a result of how the protein meal is processed.

Various issues are prevalent in the animal food industry, including inconsistent production of protein meal particles and contaminated protein meal. Manufacturers of animal protein meal must use industrial equipment to process protein meal at large scales. This results in a portion of protein meal particles being larger and insufficiently ground, which can cause inconsistent nutritional content in animal food products. Additionally, plastics, metal fragments, and other contaminants can be milled or processed along with the animal protein meal, resulting in contaminated and hazardous animal food products.

A further issue exists in the prior art, being the difficulty of controlling the balance of certain ingredients used to make animal food. For example, ash is an ingredient commonly used in animal food. Ash comes from the treatment of certain animal parts, particularly bones, with high heat. Ash is the primary source of minerals derived from animal protein used in the manufacturing of animal protein meal. However, animals cannot properly digest unlimited amounts of ash, which can cause digestive and kidney issues when overconsumed. Thus, it is desirable to control the amount of ash content in animal food products.

There currently is no efficient way to separate powdered particles in the prior art to control ingredient proportions, such as ash. The prior art does include options to reduce the number of contaminants in animal protein meal. These options include sifting and using magnets at processing checkpoints to remove ferromagnetic contaminants. However, current methods of reducing animal protein meal contaminants are generally performed early in the animal food production process and are insufficient in reducing contaminated animal food products being provided to consumers. Thus, a need exists for a method to control animal protein meal ingredient proportions, and for reducing contaminants in animal food products.

### BRIEF SUMMARY OF THE INVENTION

This invention is a system and method for purifying animal protein meal and for controlling nutritional content such as ash. The system and method remove most physical contaminants from animal protein meal, such as metal fragments, bone fragments, and plastics. The system and method also remove insufficiently ground particles and produce two separate batches of purified animal protein meal: one with high ash content, and one with little to no ash content. Furthermore, the system and method are sufficiently downstream in the process of animal food production so that new contamination is unlikely to occur.

The system generally comprises an air classifier for separating animal protein meal particles by weight and density, a first sieving module, a second sieving module, a first magnetic separator, a second magnetic separator, a first storage container, a second storage container, and a conveyer system.

The air classifier separates animal protein meal particles by weight and density, producing a heavier fraction and a lighter fraction. The heavier fraction includes particles that have more bone and ash content. The heavier and lighter fractions are directed towards a first and second track of the conveyer system, respectively.

The first track moves the heavier fraction through a first sieving module and a first magnetic separator. The first sieving module includes one or more sifting screens, allowing smaller particles to pass through the screen or screens while retaining larger particles.

The first magnetic separator may be located at the end of the first sieving module, and separates and removes ferromagnetic material.

After passing through the first sieving module and first magnetic separator, the first track deposits the remaining particles of the heavier fraction into a first storage container.

The second track moves the lighter fraction through a second sieving module and a second magnetic separator. The second sieving module includes one or more sifting screens, allowing smaller particles to pass through the screen or screens while retaining larger particles.

The second magnetic separator may be located at the end of the second sieving module, separating and removing ferromagnetic material.

After passing through the second sieving module and second magnetic separator, the second track deposits the remaining particles of the lighter fraction into a second storage container.

The method disclosed herein generally comprises separating animal protein meal particles by weight and density, sieving the separated particles, passing the separated particles through a magnetic separator, and storing the separated particles in separate containers.

Separating particles by weight and density can be accomplished by processing the particles with an air classifier and depositing the separated particles onto separate conveyer tracks.

Sieving the particles can be accomplished by passing the particles through one or more sifting screens. In various embodiments, the sifting screens are of a particular size specifically configured to retain certain material, such as metal fragments, bone fragments, and/or plastics.

Passing the particles through a magnetic separator can be accomplished by attaching a magnetic separator to each track of the conveyor system. In various embodiments, the magnetic separator is attached to each track of the conveyor system at the terminus of the sifting screens.

Storing the separated particles in separate containers can be accomplished by placing storage containers at the terminus of each track of the conveyor system to receive the particles after processing.

### BRIEF DESCRIPTION OF THE DRAWINGS

FIG. 1 is flow diagram of an embodiment of the novel method disclosed herein.

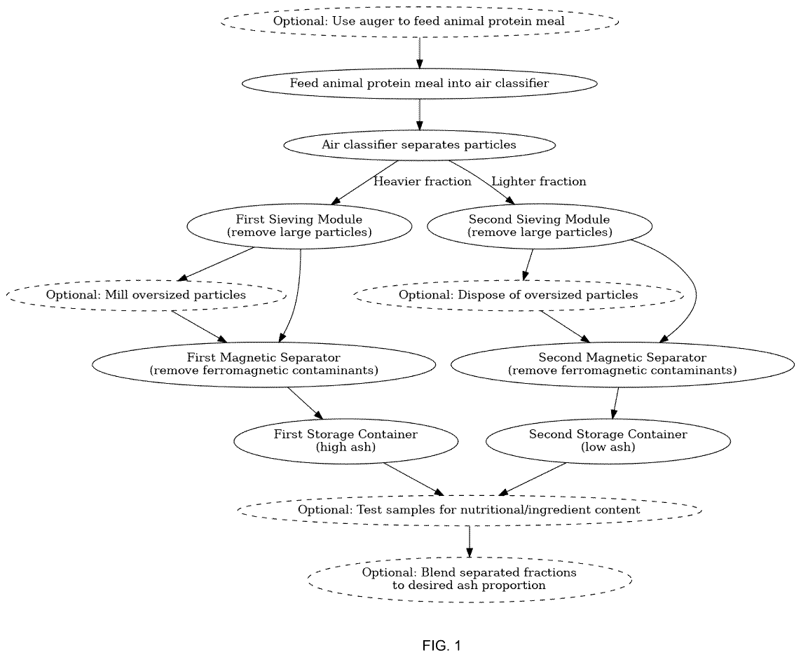

### DETAILED DESCRIPTION OF THE INVENTION

This invention is a system and method for purifying animal protein meal and for controlling nutritional content such as ash. The system and method remove most physical contaminants from animal protein meal, such as metal fragments, bone fragments, and plastics. The system and method also remove insufficiently ground particles and produce two separate batches of purified animal protein meal: one with high ash content, and one with little to no ash content.

The system generally comprises an air classifier for separating animal protein meal particles by weight and density, a first sieving module, a second sieving module, a first magnetic separator, a second magnetic separator, a first storage container, a second storage container, and a conveyer system. The system may optionally include an auger to provide animal protein meal to the air classifier.

The air classifier separates animal protein meal particles by weight and density, producing a heavier fraction and a lighter fraction. The heavier fraction includes particles that have more bone and ash content. The heavier and lighter fractions are directed towards a first and second track of the conveyer system, respectively.

The first track moves the heavier fraction through a first sieving module and a first magnetic separator. The first sieving module includes one or more sifting screens, allowing smaller particles to pass through the screen or screens while retaining larger particles.

In a preferred embodiment, the first sieving module is one or more screens attached to the first track of the conveyer system. The conveyer system feeds the heavier fraction into the screen or screens. Particles of a desirable size fall through the screens and onto a continuation of the conveyer system, while particles of an undesirable size are retained by the screens.

In various embodiments, particles retained by the first sieving module are transported to a milling unit for further breakdown and subsequent processing through the system disclosed herein.

The first magnetic separator may be located at the end of the first sieving module, separating and removing ferromagnetic material.

In a preferred embodiment, the first magnetic separator is one or more magnets with strong ferromagnetic properties attached to the conveyer system. The magnetic separator is attached just beyond the first sieving module, separating ferromagnetic material from the heavier fraction after sifting.

After passing through the first sieving module and first magnetic separator, the first track deposits the remaining particles of the heavier fraction into a first storage container.

The second track moves the lighter fraction through a second sieving module and a second magnetic separator. The second sieving module includes one or more sifting screens, allowing smaller particles to pass through the screen or screens while retaining larger particles.

In a preferred embodiment, the second sieving module is one or more screens attached to the second track of the conveyer system. The conveyer system feeds the lighter fraction into the screen or screens. Particles of a desirable size fall through the screens and onto a continuation of the conveyer system, while particles of an undesirable size are retained by the screens.

In various embodiments, particles retained by the second sieving module are disposed of as waste.

The second magnetic separator may be located at the end of the second sieving module, separating and removing ferromagnetic material.

In a preferred embodiment, the second magnetic separator is one or more magnets with strong ferromagnetic properties attached to the conveyer system. The magnetic separator is attached just beyond the second sieving module, separating ferromagnetic material from the lighter fraction after sifting.

After passing through the second sieving module and second magnetic separator, the second track deposits the remaining particles of the lighter fraction into a second storage container.

In a preferred embodiment, the first storage container receives animal protein meal with high proportions of ash.

In a preferred embodiment, the second storage container receives animal protein meal with a small proportion of ash or no ash.

The method disclosed herein generally comprises separating animal protein meal particles by weight and density, sieving the separated particles, passing the separated particles through magnetic separators, and storing the separated particles in separate containers. An optional step includes using an auger to feed animal protein meal particles onto a conveyer system, which directs the particles to a machine or device for separation. An alternative optional step includes using an auger to feed animal protein meal particles directly to a machine or device for separation.

Separating particles by weight and density can be accomplished by processing the particles with an air classifier and depositing the separated particles onto separate conveyer tracks.

Sieving the particles can be accomplished by passing the particles through one or more sifting screens. In various embodiments, the sifting screens are of a particular size specifically configured to retain certain material, such as metal fragments, bone fragments, and/or plastics.

Passing the particles through a magnetic separator can be accomplished by attaching one or more magnets with strong ferromagnetic properties to each track of the conveyor system. In various embodiments, the magnetic separators are attached to each track of the conveyor system at the terminus of the respective sifting screens.

Storing the separated particles in separate containers can be accomplished by placing storage containers at the terminus of each track of the conveyor system to receive the particles after processing.

Once the animal protein meal particles have been processed into the storage containers, samples of the particles may be tested to determine accurate nutritional and ingredient contents. After completion of any desired optional testing, the separated particles may be blended in desired proportions to produce a purified animal protein meal with a desirable proportion of ash, which is ready for extrusion.

I claim:

1. A method of purifying animal protein meal, comprising:
(a) separating animal protein meal particles by weight or density;
(b) sieving the separated particles to remove oversized particles;
(c) passing the separated particles through a magnetic separator to remove ferromagnetic material; and
(d) collecting the purified particles.

2. The method of claim 1, wherein separating by weight or density comprises using an air classifier.

3. The method of claim 1, wherein sieving comprises passing particles through one or more sifting screens configured to retain contaminants such as bone fragments, plastics, or metal fragments.

4. The method of claim 1, wherein particles retained during sieving are milled and reintroduced into the separating step.

5. The method of claim 1, wherein the separating step produces a heavier fraction enriched in ash and a lighter fraction with reduced ash content.

6. The method of claim 5, wherein the heavier fraction is sieved and passed through a first magnetic separator before collection in a first container.

7. The method of claim 5, wherein the lighter fraction is sieved and passed through a second magnetic separator before collection in a second container.

8. The method of claim 5, further comprising blending particles collected from the heavier fraction and the lighter fraction in predetermined proportions to achieve a target ash level.

9. A method of purifying animal protein meal, comprising:
(a) separating animal protein meal particles by weight and density to produce a heavier fraction and a lighter fraction;
(b) sieving the heavier fraction to remove oversized particles;
(c) passing the heavier fraction through a first magnetic separator to remove ferromagnetic material;
(d) depositing the heavier fraction into a first storage container;
(e) sieving the lighter fraction to remove oversized particles;
(f) passing the lighter fraction through a second magnetic separator to remove ferromagnetic material; and
(g) depositing the lighter fraction into a second storage container.

10. The method of claim 9, wherein the heavier fraction comprises particles with higher ash content.

11. The method of claim 9, wherein the lighter fraction comprises particles with lower ash content.

12. The method of claim 9, wherein sieving comprises passing particles through one or more sifting screens configured to retain contaminants such as bone fragments, plastics, or metal fragments.

13. The method of claim 9, further comprising milling oversized particles retained during sieving and reintroducing the milled particles into the separating step.

14. The method of claim 9, wherein the separating step comprises using an air classifier.

15. The method of claim 9, further comprising testing samples from the first and second storage containers to determine nutritional composition.

16. The method of claim 9, further comprising blending particles from the first and second storage containers in predetermined proportions to achieve a target ash level.

17. The method of claim 9, wherein sieving the heavier fraction includes passing the heavier fraction through sifting screens with at least two differing sizes of perforations.

18. The method of claim 9, wherein sieving the heavier fraction includes passing the heavier fraction through sifting screens with at least three differing sizes of perforations.

19. A system for purifying animal protein meal, comprising:
(a) an air classifier configured to separate animal protein meal particles by weight and density into a heavier fraction and a lighter fraction;
(b) a conveyor system configured to direct the heavier fraction along a first track and the lighter fraction along a second track;
(c) a first sieving module along the first track;
(d) a first magnetic separator positioned downstream of the first sieving module;
(e) a first storage container for receiving the heavier fraction;
(f) a second sieving module along the second track;
(g) a second magnetic separator positioned downstream of the second sieving module; and
(h) a second storage container for receiving the lighter fraction.

20. The system of claim 19, further comprising:
(a) an auger configured to feed animal protein meal into the air classifier;
(b) sieving modules comprising one or more sifting screens configured to retain particles larger than a predetermined size;
(c) the first storage container being configured to receive animal protein meal with high ash content;
(d) the second storage container being configured to receive animal protein meal with little to no ash content; and
(e) at least one sieving module being configured to direct retained particles to a milling unit.
